(19) United States
(12) Patent Application Publication
(10) Pub. No.: US 2024/0419015 A1
(43) Pub. Date: Dec. 19, 2024

(54) Eyeglass/Sunglass Retainer Device

(71) Applicant: Carl Gerhard Anderson, IV, Weston, CT (US)

(72) Inventor: Carl Gerhard Anderson, IV, Weston, CT (US)

(21) Appl. No.: 18/210,597

(22) Filed: Jun. 15, 2023

(51) Int. Cl. G02C 3/00; G02C 5/14

(52) U.S. Cl. CPC G02C 3/006; G02C 5/14

(57) ABSTRACT

The eyeglass retainer device uses holes in the eyeglass frame to connect to a tether which threads through loops/grommets/holes in the shirt of the wearer and is secured to the other eyeglass arm or other piece of tether (or the article of clothing itself), thus accomplishing a mechanical bond between the shirt and the wearer.

### BACKGROUND OF THE INVENTION

The use of eyewear retainers has been around for many years, and the quality of these devices—including the types of materials/cordage used, as well as the means of securing them to the glasses—have improved steadily. However, modern eyewear retainers still fail to (i) mechanically secure the eyeglass arms in a way that avoids slippage under force, and (ii) secure the eyewear (and retainer) to the wearer. This inability to ensure that eyewear will be retained by the wearer, particularly in adverse and/or dynamic environments (e.g., while surfing), have prevented eyewear from being practically employed in many environments where the benefits of eyewear (visual acuity, sun protection) are sorely needed.

Over the past few decades, several companies have designed eyewear retainers made of plastic, rubber, or nylon, which are designed to fit over the ears and securely hold sunglasses in place. These products generally consist of two main components: a pair of loops which attach to the temples of the sunglasses, and a strap or cord which runs between the loops and around the back of the head. However, existing designs do not achieve a mechanical attachment to the wearer, and therefore the eyeglasses are vulnerable to loss when hit by a wave or similar circumstances. Therefore, there is a need for a sunglasses retainer device that is simple and comfortable to wear, and can be quickly and easily secured to the wearer to avoid loss of an expensive safety article.

### SUMMARY OF THE INVENTION

In one aspect, an eyeglass retainer device uses holes in the eyeglass frame to connect to a tether which threads through loops/grommets/holes in the shirt of the wearer and is secured to the other eyeglass arm or other piece of tether (or the article of clothing itself), thus accomplishing a mechanical bond between the shirt and the wearer.

In another aspect, a system to secure eyewear involves using a flexible cord or string called a tether and a shirt or clothing item with a sewn fabric or textile loop. The tether is passed through the fabric loop, and its end is fastened to the opening or attachment point on the temple piece of the eyewear. This securely attaches the eyewear to the shirt.

Implementations of the above aspect may include one or more of the following. The fabric loop on the shirt is reinforced with additional stitching to make it strong and durable. The fabric loop is made of a material that is resistant to breaking and tearing, ensuring its longevity. The tether is adjustable, allowing the wearer to customize its length and tension according to their preference. The tether is detachable, enabling easy removal and reattachment of the eyewear whenever desired. The fabric loop is positioned on the shirt in a way that doesn't interfere with the wearer's comfort or range of motion. The fabric loop is placed on the front of the shirt, making it easily accessible and visible for the wearer. The fabric loop may include a magnetic closure, which provides a secure and convenient fastening mechanism for the tethered eyewear. The fabric loop can be positioned on the collar or neckline of the shirt, offering a secure and convenient attachment point for the eyewear. The fabric loop can also be placed on the shoulder or sleeve of the shirt, providing an alternative attachment location for the eyewear. The temple piece of the eyewear may have an adjustable fastening mechanism, making it easy and secure to attach the tether end to the opening or attachment point. The tether may include a quick-release mechanism, allowing the eyewear to be rapidly detached from the shirt in emergency situations. To ensure a reliable and sturdy connection, the tether may have a securing device such as a clasp or hook that attaches to the opening or attachment point on the temple piece. The fabric loop on the shirt can be detachable, allowing for easy replacement or interchangeability with different loops of varying designs and functions. The fabric loop may have an identification tag or label, allowing personalization or branding of the tethered eyewear system. The fabric loop can include additional pockets or compartments, providing storage space for small items like keys or earphones. The tether may have a reflective element, enhancing visibility and safety in low-light conditions. The fabric loop may include an anti-slip material or texture, preventing the tethered eyewear from sliding or shifting on the shirt. The tether may incorporate a shock-absorbing component or mechanism, protecting the eyewear from damage during rigorous activities.

In a further aspect, a method for securing the eyewear involves selecting a flexible cord or string, threading it through the opening on the temple piece, wearing a shirt with reinforced attachment points, passing the tether through these points, and securing the tether to them. This method ensures a secure connection between the sunglasses and the shirt, preventing separation during physical activities.

In yet another aspect, an eye wear or eyeglass retainer system is a secure and reliable solution designed to prevent the separation of sunglasses during various activities. This system utilizes a tether device, such as a string, to attach the sunglasses to a shirt worn by the user. The sunglasses used with this system are equipped with small holes in the arms specifically designed to accommodate the tether. The tether is fixed to the sunglass arms by threading it through the holes or loops present in the arms. This ensures a secure connection between the sunglasses and the tether. A wearer of the sunglasses then threads the tether through the shirt they are wearing. The shirt can be specifically designed for this purpose or have pre-existing holes, eyelets, or apertures through which the tether can pass. The shirt's attachment points, such as grommets or reinforced holes, are strategically placed to provide a strong and durable connection with the tether. These attachments are reinforced with additional stitching and resistant materials to minimize the risk of breakage. In addition to grommets or reinforced holes, the tether can also be secured to the shirt using other methods. For example, a reinforced tag, either attached to the interior or exterior of the shirt, can provide a secure anchor point. Alternatively, a hollow collar can be utilized, allowing the tether to be threaded through it. Once the tether is threaded through the appropriate attachment points on the sunglasses and the shirt, the sunglass retainer system is fully engaged. As long as the shirt remains attached to the wearer and neither the sunglasses nor the tether breaks, the sunglasses will stay securely connected to the wearer.

Advantages of the system may include one or more of the following. The sunglass retainer system provides peace of mind during activities where the sunglasses are at risk of being knocked off. It ensures that the sunglasses remain safely tethered to the wearer, even in rough conditions such as surfing or other strenuous activities, the advantages of this device are that it prevents loss of an expensive safety article even in a dynamic environment such as a turbulent ocean or other body of water. The device is designed to mitigate strangulation risk by using the shirt as the anchor point rather than the neck.

### BRIEF DESCRIPTION OF DRAWINGS

FIG. 1 shows an exemplary illustration of the eyeglass frame with possible locations for the passages (holes) which will be used to anchor the tether to the glasses.

FIG. 2 shows an exemplary illustration of the retainer system employing the tethers that have been secured to both arms of the eyeglass and then the tether is threaded through the passage/eyelet/grommet/tag.

FIG. 3 shows an alternative means of fastening the tether to the shirt, using a piece of fabric or textile which has been sewn onto the shirt and which creates a loop through which the tether is passed, with the end of the tether fastened to the sunglasses.

FIG. 4 shows an exemplary illustration of another alternative means of fastening the tether to the shirt, using a piece of the shirt fabric to be sewn over itself to create a loophole through which the tether is passed.

### DETAILED DESCRIPTION OF THE INVENTION

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

In the following paragraphs, the system will be described in detail by way of example with reference to the attached drawings. Throughout this description, the preferred embodiment and examples shown should be considered as exemplars, rather than as limitations on the system. As used herein, the “system” refers to any one of the embodiments of the invention described herein, and any equivalents. Furthermore, reference to various feature(s) of the “system” throughout this document does not mean that all claimed embodiments or methods must include the referenced feature(s).

This invention now will be described more fully hereinafter with reference to the accompanying drawings, in which exemplary embodiments are shown. Various embodiments are now described with reference to the drawings, wherein such as reference numerals are used to refer to such as elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the such as represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

FIG. 1 shows an exemplary illustration of the eyeglass frame with possible locations for the passages (holes) which will be used to anchor the tether to the glasses. The Sunglass 200 is a model specifically designed with a temple piece, referred to as Temple Piece 210, that incorporates openings to facilitate the attachment of a tethering system. These openings, denoted as Openings 220 and 222, allow for secure connection of the temple arm to a shirt or other article of clothing, ensuring the sunglasses remain tethered and prevent separation during various activities.

Sunglass 200 is an eyewear model that prioritizes functionality and practicality. It features a comfortable frame, high-quality lenses, and a Temple Piece 210 that is specifically engineered to accommodate a tethering system. A temple piece 210 refers to the arms or temples of the sunglasses that extend over the wearer's ears. It is designed with thoughtful modifications to enable the attachment of a tethering system. Within the Temple Piece 210, one or more openings are present: opening 220 and opening 222. These openings are strategically positioned to allow the tether to pass through and secure the sunglasses to a shirt. These openings provide attachment points for the tethering system. The openings are carefully sized and positioned to ensure a snug fit for the tether while maintaining the integrity and structural strength of the temple piece 210.

To secure the sunglasses to a shirt, the wearer can thread the tether through either Opening 220 or Opening 222. This threading process allows the tether to pass from the Temple Piece 210 through the shirt's attachment points, ultimately providing a secure connection. The tether used in conjunction with the Sunglass 200 can be a strong and durable string, cord, or similar material capable of withstanding stress and tension. It should be appropriately sized to fit through the selected opening in the Temple Piece 210. Once the tether is threaded through the chosen opening, it can be securely fastened to the shirt or its attachment points. The tether ensures that the sunglasses remain connected to the wearer, minimizing the risk of accidental loss or damage during physical activities. By incorporating Temple Piece 210 with Openings 220 and 222, the Sunglass 200 offers an effective and secure solution for attaching the sunglasses to a shirt through a tethering system. This design feature ensures that the sunglasses remain safely connected to the wearer, even during vigorous activities, providing convenience and peace of mind.

The sunglass retainer system is a system designed to allow aware of sunglasses to retain their sunglasses even if they are in rough conditions, such as surfing, and they are knocked off the persons head. The way the sunglass retainer system works is by fixing a tether to holes in the arms of sunglasses where the tether is, then stringing the tether through a shirt or other article of clothing, worn by the wearer, with the shirt having holes, eyelets, or another aperture through which the tether may pass and become mechanically secured to the shirt, thus resulting in a fully secured tethering system anchored to the shirt. The sunglasses will remain attached to the wearer, so long as the shirt remains attached, and neither the sunglasses nor the tether breaks. The shirt to which the tether attaches can have the attachments be either grommets other types of holes reinforced in the shirt, a tag, which is either interior or exterior, and is reinforced with additional stitching and a type of material that is resistant to breakage, or a collar that is hollow, and the tether can be threaded through. Other permutations of securing the tether to the shirt could be considered as well.

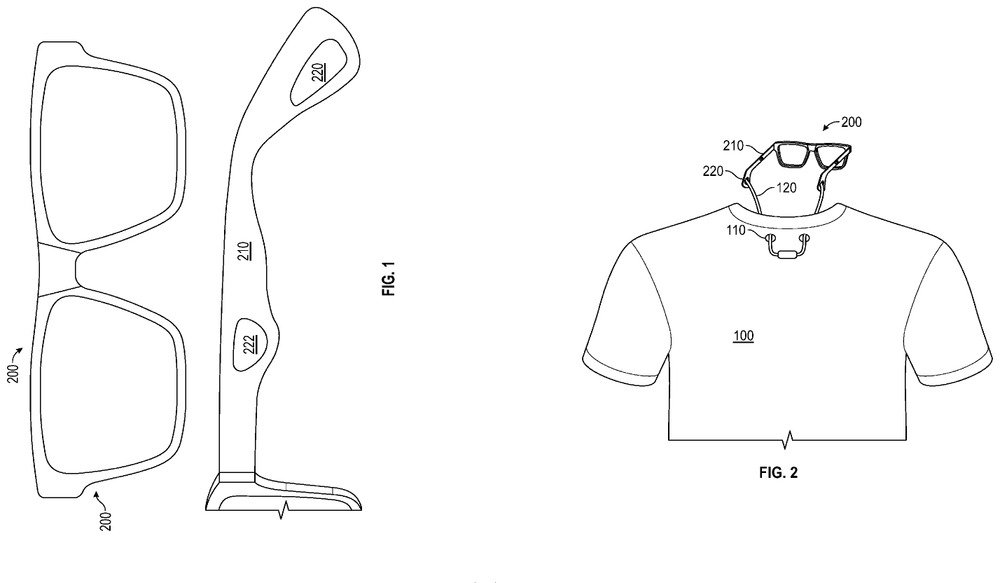

FIG. 2 shows an exemplary illustration of the retainer system employing the tethers that have been secured to both arms of the eyeglass and then the tether is threaded through the passage/eyelet/grommet/tag, among others. The tethered eyewear system employs a design where tethers are securely attached to both arms of the eyeglasses, ensuring a reliable connection. These tethers are then threaded through passages, eyelets, grommets, or tags present on a shirt or article of clothing, providing an additional layer of security and preventing the eyewear from being separated during activities.

The eyeglasses used in this system are equipped with attachment points on both arms. These attachment points allow for the secure fixing of tethers, ensuring a reliable connection between the eyewear and the tethering system. The tethers used in this system are made of durable and flexible materials such as cords or strings, capable of withstanding stress and tension. They are designed to provide a secure link between the eyeglasses and the clothing.

The shirt or article of clothing, intended to be worn by the user, is equipped with specially designed openings. These openings can be in the form of passages, eyelets, grommets, or tags, strategically positioned to allow the tethers to pass through. The user threads the tethers through the openings in the clothing, ensuring that they pass through the designated passages, eyelets, grommets, or tags. This threading process creates a secure pathway for the tethers to be mechanically anchored to the clothing. The passages, eyelets, grommets, or tags on the clothing are reinforced to enhance their strength and durability. This reinforcement can be achieved through additional stitching, using resistant materials, or employing reinforcement plates to prevent breakage or tearing. Once the tethers are properly threaded through the openings on both sides of the eyeglasses and the clothing, the system becomes fully engaged. The eyewear remains attached to the wearer as long as the clothing remains intact and neither the tethers nor the attachments break.

The tethered eyewear system provides a reliable and secure solution for preventing the separation of eyeglasses during various activities. By securely coupling the tethers to both arms of the eyewear and threading them through reinforced openings in the clothing, the system ensures that the eyeglasses remain safely attached to the wearer, minimizing the risk of loss or damage.

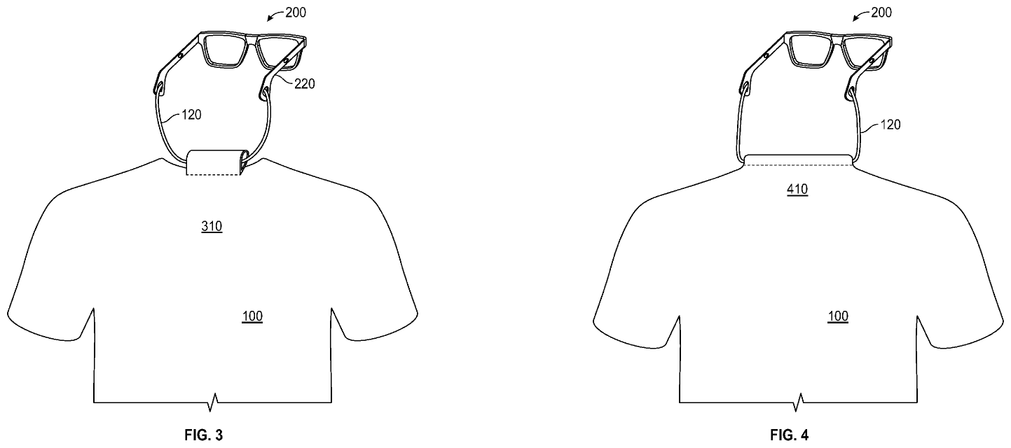

FIG. 3 shows an alternative means of fastening the tether to the shirt, using a piece of fabric or textile which has been sewn onto the shirt and which creates a loop through which the tether is passed, with the end of the tether fastened to the temple piece 210. The alternative means of fastening the tether to the shirt involves using a piece of fabric or textile that has been sewn onto the shirt, creating a loop through which the tether is passed. The end of the tether is then fastened to the temple piece of the eyewear, providing a secure attachment.

In the embodiment of FIG. 3, a loop is created on the shirt or article of clothing by sewing a piece of fabric or textile onto it. This loop serves as an attachment point for the tether. The fabric or textile is securely stitched onto the shirt, ensuring durability and strength. The stitching may involve reinforcement techniques, such as double stitching or using strong thread, to withstand tension and pulling forces. The fabric or textile loop can be strategically positioned on the shirt to optimize functionality and wearer comfort. It may be placed on the front portion of the shirt for easy access and visibility, on the collar or neckline for convenience, or on the shoulder or sleeve as an alternative attachment location. The fabric or textile loop is designed to accommodate the tether's size and allow smooth passage through it. The loop can be rectangular, circular, or any other suitable shape, ensuring a secure fit for the tether. The tether, which is a flexible cord or string, is passed through the fabric or textile loop. The loop creates a pathway for the tether to thread through, establishing a connection between the eyewear and the shirt. Once the tether is threaded through the fabric or textile loop, the end of the tether is securely fastened to the opening or attachment point on the temple piece of the eyewear. This fastening can be achieved through various mechanisms, such as knots, clasps, hooks, or adjustable fasteners, ensuring a reliable attachment. The combination of the fabric or textile loop on the shirt and the fastened tether on the temple piece provides a secure attachment system for the eyewear. The loop prevents the tether from slipping or coming undone, ensuring that the eyewear remains securely connected to the shirt during various activities.

This alternative means of fastening the tether to the shirt using a fabric or textile loop provides a reliable and convenient attachment method for the eyewear. The sewn loop creates a stable connection point, and when combined with the securely fastened tether, it ensures that the eyewear remains safely attached to the shirt, minimizing the risk of loss or damage.

FIG. 4 shows an exemplary illustration of another alternative means of fastening the tether to the shirt, using a piece of the shirt fabric to be sewn over itself to create a loophole through which the tether is passed, with the end of the tether fastened to the other sunglasses arm. This alternative means of fastening the tether to the shirt involves utilizing a piece of the shirt fabric itself. This method entails sewing a portion of the shirt fabric over itself to create a loophole through which the tether is passed. The end of the tether is then fastened to the other arm of the sunglasses, ensuring a secure attachment. A portion of the shirt fabric is selected, typically near the collar or shoulder area, to create a loophole. This section of fabric will be used to form the attachment point for the tether. The selected portion of fabric is folded over itself, creating a loop or fold in the fabric. The fabric is then securely sewn together, ensuring that the loop remains intact. This sewing process can involve techniques such as double stitching or using strong thread to reinforce the loop. The size of the fabric loop is determined based on the desired fit for the tether. It should be large enough for the tether to pass through smoothly. The loop is strategically positioned on the shirt, considering wearer comfort and accessibility. The tether, which is a flexible cord or string, is passed through the fabric loophole. The fabric loop serves as a pathway for the tether, allowing it to be threaded through the shirt fabric. After passing the tether through the fabric loophole, the end of the tether is securely fastened to the other arm of the sunglasses. This fastening can be achieved through various methods, such as knots, clasps, hooks, or adjustable fasteners, ensuring a reliable attachment to the sunglasses. The combination of the fabric loophole on the shirt and the fastened tether on the sunglasses creates a secure attachment system. The fabric loop prevents the tether from slipping or coming undone, while the fastened tether on the sunglasses ensures that they remain securely attached to the shirt during activities. This alternative means of fastening the tether to the shirt using a fabric loophole provides a practical and customizable attachment method for the sunglasses. By utilizing a portion of the shirt fabric itself, this method offers a seamless and integrated solution. The fabric loophole, along with the securely fastened tether, ensures that the sunglasses remain securely attached to the shirt, providing convenience and minimizing the risk of loss or damage.

The system relates generally to a system for securing eyewear to an article of clothing, such as a shirt or a coat, in order to prevent the loss or damage of the eyewear when not in use. In particular, the inventive system utilizes a tether, which attaches to the temple piece of the eyewear and a fabric or textile loop sewn onto the article of clothing. This system is particularly advantageous for those individuals who frequently use various types of eyewear, as well as for those who require the use of protective eyewear in certain work environments and wish to ensure that their eyewear is always easily accessible and secure from damage.

Typically, when individuals remove their eyewear, they often place the eyewear in their pockets, on their work surfaces, or hang them from the neckline of their clothing. However, these practices can result in a myriad of issues associated with loss, damage, and the hygienic concerns that stem from the eyewear coming into contact with unclean surfaces. Furthermore, eyewear cases can be bulky and inconvenient to carry around, and they may not always provide the desired level of accessibility for users who frequently need to remove and put on their eyewear. The invention described herein aims to address these issues by providing a simple, reliable, and convenient means to secure eyewear to an article of clothing, thereby helping to protect the eyewear and ensuring its constant accessibility.

The inventive system consists of a tether made from a flexible cord or string, and a fabric or textile loop which is sewn onto an article of clothing, such as a shirt or a coat. The tether can be made from a variety of materials, including but not limited to nylon, polyester, or elastic materials, which provide the flexibility to accommodate movement and the durability to withstand wear and tear. The fabric or textile loop can be sewn onto the clothing in a variety of positions, such as on the upper arm, shoulder, chest, or collar area, depending on the preferences of the user and the specific requirements of the intended use.

In order to attach the eyewear to the shirt, the tether is passed through the fabric or textile loop. The end of the tether is then fastened to the opening or attachment point on the temple piece of the eyewear, typically via a small hook, clip, or loop, depending on the design of the eyewear. Once secured, the tether ensures that the eyewear remains attached to the article of clothing, providing a stable and convenient means of storing the eyewear while not in use.

The system described above is versatile and adaptable for a wide range of different eyewear styles and types, including sunglasses, prescription glasses, and safety glasses. Additionally, the tether may be easily adjusted in length depending on the preferences of the user, as well as the specific requirements of the intended use. For example, individuals who require the use of protective eyewear in their work environment may prefer a shorter tether length to ensure that their eyewear remains securely attached to their clothing and does not swing around too freely when not in use.

Another advantage of the inventive system is that it can be easily incorporated into various types of clothing, including custom-designed shirts, jackets, and uniforms that are tailored to meet the needs of specific industries or professions. In this manner, the system can seamlessly integrate into existing work attire, ensuring that individuals are able to easily and securely store their eyewear while on the job, and reducing the risk of loss or damage to their eyewear.

The system for securing eyewear with a temple piece to an article of clothing provides a simple, reliable, and convenient solution for individuals who frequently use or require the use of eyewear. By utilizing a tether and fabric or textile loop, the invention ensures that eyewear remains securely attached to clothing, while also providing users with constant and easy accessibility to their eyewear. This inventive system can be easily adapted for use with a wide range of eyewear styles, types, and clothing options, making it a versatile solution for users as well as businesses in various industries.

In recent years, there has been a growing demand for improved, high-quality textiles and fabrics that can withstand the test of time and various environmental factors, such as wear and tear, UV radiation, and moisture. This has led to the development of various methods and technologies aimed at enhancing the durability and performance of textiles. One such method involves reinforcing fabric or textile loops with additional stitching. The system provides an innovative and effective way of reinforcing loops in fabrics and textiles to ensure durability and strength, meeting the increasing demands of consumers and industries alike.

One implementation pertains to a fabric or textile loop comprising a base material and an added reinforcement stitching. The base material could be made of natural or synthetic fibers, such as cotton, polyester, silk, wool, or any other suitable material, or a blend of any of these materials. In some embodiments, the base material may also be made of a combination of fibers and non-fibrous materials, such as polymers or fillers, to ensure desired properties in the final fabric or textile. The reinforcement stitching may be a series of stitches, that may be identical to or different from the stitches used in the base material, which serves to increase the load-bearing capacity of the loop and improve its overall durability. The stitches can be applied uniformly throughout the loop or selectively, for instance, around the areas prone to tearing or frictions. The reinforcement stitches may be added using conventional sewing techniques, or using a specialized sewing machine designed or configured specifically for this purpose. Moreover, the reinforcement stitching can be added during the initial manufacturing of the fabric or as a post-processing step, depending on the specific requirements of the end product.

The fabric or textile loop utilized in the invention is made of a material that is specifically engineered to be resistant to breakage and tearing. This material may be constructed using high-quality fibers, such as synthetic fibers, natural fibers, or blends thereof. Examples of suitable materials include but are not limited to nylon, polyester, aramid fibers (such as Kevlar®), ultra-high-molecular-weight polyethylene (UHMWPE) fibers (such as Dyneema®), and any other fibers known to possess high tensile strength, abrasion resistance, and resistance to degradation by environmental factors, such as ultraviolet radiation, moisture, and chemical agents. The loop may be created by weaving, knitting, or braiding these fibers together to create a strong, unified structure that is capable of supporting significant loads without failing or tearing. Additionally, the loop may be provided with various coatings, finishes, or treatments that enhance its resistance to environmental factors, such as water, dirt, or chemicals, and further improve its durability and longevity.

The integration of a breakage and tear-resistant fabric or textile loop in the inventive system has several key advantages and benefits. Firstly, the improved strength and durability of such fabric loops make them more reliable and secure than traditional loops, which may be prone to breakage and tearing under various loading conditions. This translates to enhanced safety and security, as well as a reduced risk of failure and the potential for damage to goods or injury to users. Moreover, the use of high-quality materials in the construction of the fabric loops means that the life span and serviceability of the invention are significantly extended, resulting in a more cost-effective and sustainable solution. Finally, the increased versatility and adaptability of the fabric loop system allow it to be utilized in a wide range of applications, from personal and professional gear, to securing and anchoring systems in various industries, such as transportation, military, aerospace, and construction, among others.

The system relates to a novel wearable system designed to enhance the user experience and ensure maximum comfort, versatility, and customization. The system comprises a comfortable, adjustable strap worn around the user's waist or torso, with an attached tether that can be connected to various objects or devices. This system is particularly useful for individuals engaging in activities such as running, hiking, or other outdoor pursuits, wherein their hands may be occupied and they require a secure and convenient means of connecting certain devices, items or accessories to their person.

The adjustable strap of the invention is designed to securely and comfortably fit around the wearer's waist or upper torso, depending on their preference. The strap material comprises a high-quality, durable fabric with an adjustable buckle or clasp mechanism that allows the user to modify the tightness and fit according to their body size or shape. The invention provides optimum comfort and support, by distributing the weight of the attached objects across the user's waist or torso evenly, reducing the strain on their hands and arms and enabling them to perform activities with ease.

The tether, a key component of the wearable system, is comprised of an extendable, high-strength material that can be adjusted to the desired length and tension, providing the user with a customized fit and level of security. The tether can be connected to various objects, devices, or accessories such as smartphones, cameras, water bottles, or other items that may be necessary during outdoor pursuits or adventurous activities. A strong and secure connection ensures the user's devices or other objects remain safely attached to their person, while allowing them the flexibility to access and use these items as needed without hindrance or interference. The adjustable tether also offers additional convenience and ease of use, as it enables the wearer to modify its length and tension to suit their particular needs and preferences.

The system provides a versatile and innovative wearable system that caters to individuals who are constantly on the go and require a secure, comfortable, and customizable means of connecting their devices or accessories to their person while participating in various activities. The adjustable strap and tether offer unparalleled levels of comfort, security, and customization, ensuring the wearer has the freedom to fully engage in their chosen pursuits without worrying about the safety and accessibility of their attached objects or devices.

The system relates to a novel and innovative system for eyewear attachment, which enhances the user experience by providing a detachable tether for eyewear. The primary objective of such an eyewear attachment system is to facilitate the convenient removal and reattachment of the eyewear as per the wearer's preference while maintaining functionality and aesthetic appeal. The invention is designed to be versatile, user-friendly, and efficient, making it suitable for various types of eyewear, including but not limited to sunglasses, prescription glasses, safety goggles, and sports eyewear.

In one embodiment, the inventive eyewear system comprises a pair of eyeglasses with a detachable tether that connects the eyeglasses to the wearer. The tether is designed to be easily removable and attachable, thus offering the wearer the flexibility to use the glasses with or without the tether, as desired or required. The tether may be made of various materials, such as plastic, metal, fabric, or a combination of materials, and can be adjustable in length to accommodate the wearer's preferences and needs. The detachable mechanism can be provided through various means, including but not limited to clasps, hooks, magnets, or other fastening techniques. This inventive feature simplifies the eyewear attachment process, reduces the risk of eyewear loss, and caters to the ever-changing needs of the user.

The practical advantages of the inventive detachable tether system are numerous. By allowing the wearer to easily remove or attach their eyewear, the invention increases the overall utility and versatility of the eyewear. For instance, a user could quickly remove their sunglasses when entering an indoor environment with dim lighting and reattach them when stepping back outdoors. Moreover, the detachable tether feature offers an added layer of security and convenience, preventing the eyewear from falling off during physical activities such as running, cycling, or engaging in sports. Additionally, the ability to detach the tether provides a more comfortable and customizable eyewear experience, as the wearer has the option to adjust the tether's length or remove it entirely. Furthermore, the detachable tether system can improve the longevity of the eyewear, as the risk of strain on the eyewear frame or lenses caused by the fixed attachment of a tether is reduced.

The system presents a novel and inventive eyewear attachment system that incorporates a detachable tether for enhanced functionality, versatility, and user satisfaction. The system allows the wearer to easily remove or reattach their eyewear as needed and is compatible with multiple eyewear types, making it ideal for various applications and environments. The detachable tether system also provides added security and convenience, ensuring that the eyewear remains intact and functional even during strenuous activities. With the numerous benefits it brings, the inventive detachable tether system for eyewear is a highly desirable and practical innovation in the field of eyewear technology.

The improved fastening system can be used for securing and organizing electronic devices, personal items, and accessories to a shirt or article of clothing. This innovative attachment mechanism utilizes a fabric or textile loop affixed to the exterior or interior surface of the shirt or article of clothing, forming a discrete and convenient means of keeping items securely in place and easily accessible for the wearer.

In a preferred embodiment of the invention, the fabric or textile loop is strategically positioned on the shirt or article of clothing, taking into consideration the wearer's comfort and range of motion during activity. The loop may be situated in various locations, such as on the chest, shoulder, or side of the shirt or clothing article, depending on the user's preference and use case scenario. Different sizes and shapes of loops can be provided to accommodate various items and combinations of items, such as headphones, earbuds, charging cords, eyeglasses, pens, or any item that can be tethered, affixed, or clipped to the loop. In order to provide a proper fit, the loop should be of sufficient size to securely hold the item, but not too large, so as to prevent unintentional disengagement or loss of the item.

The fabric or textile loop may be formed from a wide variety of durable materials including, but not limited to, cotton, nylon, polyester, neoprene, or a blend thereof. It can be attached to the shirt or article of clothing using various techniques, such as sewing, heat bonding, or adhesive attachment. In some embodiments, a removable and reusable attachment mechanism, such as Velcro®, may also be employed to enable easy repositioning of the loop according to the wearer's preference and to facilitate the removal of the loop for cleaning or laundering. Furthermore, the loop may include additional features such as a quick-release mechanism to allow for rapid detachment and reattachment of items, or a cinching mechanism to adjust the tightness or size of the loop to accommodate different types and combinations of items.

This system serves to provide a novel solution to conveniently manage and secure personal belongings while promoting user comfort and freedom of movement. By offering a simple yet effective fastening system that can be integrated into various garments, it caters to the need of organization, accessibility, and flexibility in today's fast-paced, connected society. This versatile attachment mechanism is ideal for individuals who frequently engage in physical activities, outdoor sports, or professionals on the go, ensuring their personal items remain secure and easily reachable at all times.

The eyewear includes, but is not limited to, sunglasses, prescription eyeglasses, and safety goggles. The invention specifically relates to a fabric or textile loop positioned on the front portion of the shirt or article of clothing. The loop, designed to hold the arm or temple of the eyewear, is positioned in a way that it enables easy access and visibility while simultaneously securing the eyewear to the clothing item, preventing accidental displacement or dropping.

The fabric or textile loop can be permanently or detachably affixed to the shirt or article of clothing through various means, including but not limited to sewing, adhesive, Velcro, or magnetic mechanisms. The loop is designed to accommodate a variety of eyewear temple or arm sizes and can be adjustable in order to cater to the specific size and shape of the eyewear to be held. Furthermore, the fabric or textile loop may be available in a wide array of designs and colors to match or complement the design of the shirt or article of clothing it is attached to. Additionally, this system could potentially be integrated with various articles of clothing, such as jackets, vests, and hats, broadening the scope of applicability and utility.

The system eliminates the need for additional equipment or accessories, such as eyewear straps or chains, that may be cumbersome or inconvenient to use in certain situations. The direct attachment of the fabric or textile loop to the shirt or article of clothing provides a streamlined and efficient process for securing eyewear and allows for quick and easy access whenever required. Second, the positioning of the loop on the front portion of the shirt or article of clothing ensures the tethered eyewear is always visible, significantly reducing the chances of accidental loss or misplacement. Lastly, the versatile, adjustable, and customizable nature of the loop provides a high level of adaptability and durability that makes this system suitable for use by people of various ages, sizes, and fashion preferences.

The a tethered eyewear system provides a unique and innovative solution to a common problem faced by eyeglass wearers—the misplacement or accidental loss of their glasses. Eyeglasses, sunglasses and other forms of eyewear are essential accessories for millions of individuals that require vision support on a daily basis or protection from the glare of the sun. Despite their necessity, eyewear can be inconvenient to keep track of and safeguard from damage, as they are often taken on and off throughout the day. Accordingly, the invention provides a means of securing eyewear to a user's clothing or accessories, while offering ease of access as needed.

The primary component of the inventive tethered eyewear system comprises a fabric or textile loop designed to snugly and securely encircle the temple arm of the user's glasses. This attachment to the glasses provides a stable connection, allowing the user to easily remove and reintroduce the glasses without fear of them falling or getting misplaced. The complementary part of the system is the fastening mechanism, which is a magnetic closure in this instance. The magnetic closure ensures that the tethered eyewear can be swiftly connected and detached from the user's clothing, bags, or other accessories. The combination of these two elements provides users with a reliable means of keeping their eyewear tethered to their person while still allowing for comfortable and unencumbered use.

The magnetic closure of the fabric or textile loop offers several advantages over conventional eyewear fastening solutions. Firstly, the magnetic fastening mechanism allows for quick and easy release of the tether, without the need to fiddle with snaps, buttons, or other cumbersome fasteners. Secondly, the use of magnets ensures a strong and secure connection between the loop and the user's clothing or accessory, efficiently preventing unintentional detachment and subsequent loss of the glasses. Lastly, the design of the tethered eyewear system is discreet, blending seamlessly with the user's outfit and style while still providing utility. This presents a far more elegant and practical solution as compared to other available eyewear retention options, such as neck straps or lanyards, which may be uncomfortable or unsightly.

The tethered eyewear system disclosed herein provides a smart and stylish solution to the ever-present issue of securing eyeglasses, sunglasses, or other forms of eyewear for users. The combination of a fabric or textile loop with a magnetic closure fastening mechanism ensures the eyewear remains safely and securely tethered to the user's clothing or accessories while allowing for easy access and removal as needed. This invention presents a significant advancement in eyewear retention technology, overcoming the limitations and drawbacks associated with other forms of eyewear fasteners currently available in the market.

The system is primarily targeted at improving the convenience and utility of wearing and handling eyeglasses while engaged in various activities. Specifically, the invention involves a system to tether eyeglasses securely and conveniently when not in use by attaching them to a collar or neckline of a user's shirt using a fabric or textile loop. The tethered eyewear system offers a practical solution for those who frequently wear eyeglasses but may need to remove them at times or have them readily accessible during different situations, such as work, sports, or daily life.

The fabric or textile loop is designed to be positioned on the collar or neckline of any shirt, including casual and formal wear. The loop can easily be attached to the shirt by sewing, gluing, snapping or various other attachment means, allowing for a wide range of compatibility with different fabric types and clothing styles. This loop is intended to be durable and non-abrasive, ensuring that it can withstand the wear and tear of daily use and does not cause discomfort to the user. Additionally, the loop may come in various sizes, designs, and materials to cater to different aesthetics and requirements.

The eyewear tethering mechanism firmly holds the eyeglasses in place and enables easy removal when needed. This mechanism can involve a hook, clasp, magnetic attachment, or any other coupling device that securely connects the eyeglasses' temple to the loop on the shirt's collar or neckline. This tethering system ensures that the eyeglasses do not slip off and fall while being suspended, giving the user peace of mind, especially during high-motion activities. The tether also allows the user to remove their glasses quickly and easily without fearing displacement or loss, making the transition from wearing to storing the eyewear seamless and efficient.

The fabric or textile loop and a secure tethering mechanism provides unmatched convenience and utility for eyeglass wearers, minimizing the risk of losing or damaging their eyewear while promoting ease of access. This invention is adaptable to an extensive array of clothing items and eyeglass designs, ensuring its universal applicability and adoption in various settings. Whether it be during work, sports or any other activities, the tethered eyewear system enhances the user's experience, offering a reliable and practical solution to managing their eyeglasses.

The system can secure eyewear, such as sunglasses or prescription glasses, to a shirt, jacket, or other upper garment, thereby providing the user with a convenient and secure method of storing their eyewear when not in use. The invention includes a fabric or textile loop, strategically positioned on a shoulder or sleeve of the upper garment and a detachable tether that serves to connect the eyewear to the loop. This method ensures that the wearer's eyewear remains secure and readily accessible, even when engaging in a range of physical activities. With the flexible attachment and placement options offered by the invention, the user can retain their eyewear without risk of losing or misplacing it.

The fabric or textile loop utilized in the system can be crafted from a variety of materials, such as nylon, polyester, or elastic, being durable and resistant to wear and tear. The loop is designed to be sufficiently large to allow the arm of various eyeglasses to be passed through with ease, yet tight enough to hold the eyewear securely in place. The loop is easily and securely fastened to the shoulder or sleeve of the shirt by means such as sewing, adhesive, or other appropriate attachment methods. The positioning of the loop on the garment ensures that eyewear can be securely stored without impeding the wearer's motion, while the detachable tether allows users to quickly and effortlessly remove their eyewear for use when required.

The detachable tether of the invention is comprised of a flexible and durable cord, such as nylon, polyester, or other suitable materials, and features a secure attachment mechanism at both ends. One end of the tether is equipped with a clasp or fastener, designed to attach to the arm of the eyewear, while the other end is fitted with a similar attachment mechanism to securely attach to the fabric or textile loop on the shoulder or sleeve of the garment. The tether may be adjustable in length to accommodate various user preferences or can be designed as a fixed length, depending on the specific requirements of the user. The detachable tether allows the eyewear to be easily secured and removed from the loop as needed, providing the user with a practical and efficient method of storing and accessing their eyewear. With the inventive eyewear securing system, users can enjoy both convenience and peace of mind in knowing that their eyewear is safely stored in a readily accessible location regardless of their physical activities. The unique eyewear retention system designed to securely fasten eyewear to the user's head or clothing, reducing the risk of accidental dislodgment, slippage, or total loss of the eyewear. The system is comprised of a tether, an adjustable fastening mechanism on the temple piece of the eyewear, and an opening or attachment point on the user's clothing or head apparel. The invention provides a practical solution to common problems associated with conventional eyewear, such as falling off during physical activities or slipping down the nose due to perspiration or the weight of the eyewear itself. Additionally, the system poses a significant advantage over existing eyewear retention products, as it can be easily adjusted to accommodate various head sizes, eyewear designs, and attachment point options, providing users with a versatile, customizable, and comfortable eyewear retention system.

The tether can have a first end for connecting to the adjustable fastening mechanism and a second end for attachment to the user's clothing or head apparel. The tether may be constructed from a wide variety of durable, lightweight, and flexible materials, including but not limited to, fabric, elastic, rubber, silicone, or a combination thereof. The tether may be of any suitable length or width, provided that it is long or wide enough to securely hold the eyewear on the user's head or clothing, while not causing discomfort or hindering the user's activities. Additionally, the tether may be designed to be detachable or retractable, allowing users to easily remove the tether when not in use, or extend and retract the tether as needed.

An adjustable fastening mechanism can be located on the temple piece of the eyewear, allowing for easy and secure attachment of the tether end to the opening or attachment point. The mechanism may comprise a hook, loop, clamp, clip, or other suitable attachment means, and may be designed to slide, rotate, or otherwise adjust along the temple piece, thereby accommodating various head sizes and eyewear designs. The adjustment mechanism may also include a locking feature, such as a notch, detent, or ratcheting system, to prevent the tether from becoming inadvertently detached or loosened during use. The adjustable fastening mechanism may be permanently affixed to the eyewear, or may be designed as a removable attachment that can be easily installed and removed by the user.

The opening or attachment point on the user's clothing or head apparel provides a secure and convenient means for connecting the tether to the wearer. This attachment point may take the form of a loop, grommet, clip, button, or other suitable fastening means, and may be incorporated into a hat, headband, collar, lapel, or other clothing item. Alternatively, the attachment point may be a separate accessory that can be temporarily or permanently affixed to the user's clothing or head apparel using adhesive, hook and loop fastening, or other suitable attachment means. By providing a wide range of attachment point options, the invention allows users to customize their eyewear retention system to their unique preferences and needs, ensuring maximum comfort, versatility, and practicality.

The eyewear tethering system that is adaptable for use in conjunction with a wide variety of eyewear types and configurations, including but not limited to eyeglasses, sunglasses, and protective goggles, and which offers superior comfort and convenience for the wearer compared to existing eyewear tethering solutions.

The eyewear tethering system can have a flexible, elongated tether that can be securely fastened to a conventional shirt collar, and from which the tether can be easily wrapped around, and affixed to, the temples of the eyewear. The tether is designed such that it may be manufactured in a range of lengths to accommodate different user preferences and eyewear configurations, thereby providing a customizable fit that does not restrict the movement of the user's head and neck and which allows the user to move the eyewear either upwardly or downwardly when not in use, without fear of losing or damaging the eyewear. The tether further includes a quick-release mechanism that is designed to enable rapid detachment of the tethered eyewear from the shirt in emergency situations, and without necessitating the complete removal of the shirt.

In one embodiment, the quick-release mechanism comprises a small, lightweight clasp that is easily and securely attachable to the shirt collar, and which may be disengaged upon the application of a predetermined level of force by the user. In another embodiment, the quick-release mechanism may be activated by pulling a release tab provided on the underside of the clasp. The invention thus provides a unique, simple, and effective means for securing one's eyewear against loss or damage, while also providing the user with ready access to their eyewear as needed. The invention's sleek and unobtrusive design also avoids the bulk and discomfort often associated with conventional eyewear tethers, and the quick-release mechanism adds an extra level of safety not found in existing tether systems.

In another implementation, the tethering system comprises a flexible tether that extends from one of the temple pieces of the eyeglasses and is further provided with a securing device, such as a clasp or hook. The securing device is configured to attach the tether to an opening or attachment point on the temple piece, or other suitable locations such as the wearer's shirt collar, belt loop, or bag strap, thereby preventing the eyeglasses from being inadvertently lost or damaged. The inventive tethering system effectively addresses the issues of securing and keeping track of one's eyeglasses, particularly when the eyeglasses are not being worn. The tether is made from a suitable flexible material, such as nylon or other synthetic fibers, silicone, or metal chains, and is of an appropriate length to permit the wearer to easily secure the device to the desired attachment point. The securing device can be a variety of mechanisms including, but not limited to, a clasp, hook, or loop that can be easily and securely fastened to the attachment point. The securing device can be releasably attached to the tether, thus allowing the wearer to interchange various securing devices with different attachment point types.

In another aspect of the invention, the attachment point on the temple piece can be internal or external. In the case of an internal attachment point, the temple piece may have a cavity or recess to accommodate the tether and the securing device, thereby providing a more streamlined and aesthetically pleasing appearance of the eyeglasses. Alternatively, in the case of an external attachment point, the tether and the securing device can be externally attached to, or integrally formed with, the temple piece. In either case, the attachment point should be configured to securely hold the tether and the securing device during normal use of the eyeglasses while permitting easy detachment and reattachment of the tether.

The system relates to a detachable and interchangeable fabric or textile loop specifically designed for enhancing the aesthetics, functionality, and versatility of various personal items, accessories, and other objects. The fabric or textile loop may be easily attached and detached to different items, providing users with the ability to easily and efficiently change the look, style, or function of their selected personal items, accessories, or other objects. The detachable loop may be crafted from a variety of materials, such as fabric, textiles, leather, or other suitable materials, and may be available in different colors, patterns, textures, or other customizable aspects, offering users a wide range of options to personalize their items.

In one aspect of the invention, the fabric or textile loop comprises an elongated strip of material, which may be configured into a loop by connecting the two ends of the material strip using a fastening system. The fastening system may be in the form of buckles, snaps, buttons, hook and loop closures (e.g., Velcro), or other suitable fastening mechanisms. The loop may be designed to easily and securely attach to various objects, such as bag handles, keychains, wristbands, belts, or other similar personal items or accessories. The choice of fastening system may serve to ensure both a secure attachment and ease of removal and replacement with different loops, enabling users to quickly and efficiently customize their belongings without the need for specialized tools, equipment, or training.

In another aspect of the invention, the detachable fabric or textile loop may additionally provide enhanced functionality when attached to certain types of objects. For example, loops constructed from specific materials or with specific designs may possess qualities such as insulation, water resistance, or durability, which in turn may protect or enhance the object to which it is attached. In addition, the loop may feature pockets, compartments, clips, or other built-in elements that add to the utility of the object it is attached to, such as by providing storage options or organization solutions. In this manner, the detachable and interchangeable fabric or textile loop not only serves to enhance the personalization and aesthetic appeal of various objects, but may also offer a range of functional benefits as well.

The tethered eyewear system can provide a secure, convenient, and versatile means of retaining eyewear when not in active use. The tethered eyewear system features a fabric or textile loop that is adjustable and resilient, coupled with attachment means to secure the eyewear in place. Utilizing this system allows the user to easily and quickly remove their eyewear and have it hang around their neck, providing immediate accessibility and reducing the likelihood of misplaced or lost eyewear. The fabric or textile loop also includes an identification tag or label, providing a means for personalization or branding of the tethered eyewear system. This feature enhances the appeal of the system to users who wish to make a personal statement with their eyewear accessories or promote a specific brand.

In one embodiment, the tethered eyewear system is comprised of a fabric or textile loop constructed of flexible, high-quality, and durable materials that provide sufficient strength and resilience to ensure that the eyewear is securely retained in the loop. The loop is designed to be adjustable in size, enabling it to accommodate a variety of eyewear styles and sizes comfortably. The attachment means may include, but is not limited to, a pair of eyewear connector components that secure the eyewear to the loop. These connector components may be constructed from materials such as plastic, rubber, or metal and are designed to securely grip the eyewear's temples or arms without causing damage or discomfort. The connector components may be detachable from the loop, allowing the user to easily replace or interchange them to accommodate different eyewear styles or sizes.

In another embodiment, the fabric or textile loop features an identification tag or label, which can be customized to display a specific logo, name, or design. This personalized tag or label may be permanently affixed to the loop or removable and replaceable to suit the user's preferences and personal style. This feature presents an opportunity for customization and branding, offering the user the flexibility to express their unique sense of style or support a particular brand by displaying its logo or symbol. Additionally, this branding feature may be advantageous to manufacturers, retailers, and other entities seeking to promote a specific brand, product, or cause, as it allows them to produce a customizable, versatile, and functional accessory that is aligned with their marketing and promotional goals. The tethered eyewear system of the system provides a secure, convenient, and versatile solution for retaining eyewear when not in active use. The adjustable fabric or textile loop, coupled with attachment means to secure the eyewear in place, ensures that a wide variety of eyewear styles and sizes can be accommodated, while the identification tag or label presents opportunities for personalization and branding. These features, in combination, make the tethered eyewear system a valuable and practical accessory for eyewear users, as well as an attractive promotional tool for businesses and organizations.

In another implementation, a fabric or textile loop, formed by folding the fabric material in a manner that overlaps the ends and secures them together. The fabric material may include stretchable, weather-resistant, or breathable properties, allowing it to maintain its shape and performance over numerous cycles of use. The loop may be further adjusted according to the user's preferences by employing various attachment means such as snaps, buttons, hook-and-loop fasteners, or adjustable fasteners, thus enabling it to fit around various body parts or objects, such as the user's wrist, arm, or a bag strap. The flexibility and adjustability of the loop allow users to utilize the invention in various settings and for an assortment of purposes.

The fabric or textile loop is uniquely designed to include a plurality of additional pockets or compartments, offering ample storage space for the user's essential items. These pockets may be formed through stitching, heat sealing, or by other means, and may vary in size, shape, or depth for accommodating different items. Some of the pockets may be enclosed by zippers, Velcro, or other closure means, ensuring the secure storage of the user's belongings. The pockets may be strategically positioned around the loop to facilitate easy access and retrieval of items without needing to remove and disassemble the invention. With the inclusion of such pockets and compartments, the system not only provides convenient storage and transportation of personal items but also promotes a sense of organization and efficiency, allowing users to focus on their desired activities uninterrupted by concerns over lost or misplaced items.

The system relates to an innovative system that serves as a versatile, multi-functional, and practical solution to improve the daily lives' of users, especially those involved in the sporting or outdoor industries. Specifically, it addresses a wide range of challenges commonly faced by individuals during their daily activities, work-outs, hikes, and other adventures. This highly inventive system includes an adjustable tether, allowing users to securely attach and hold their personal belongings while also providing enhanced visibility and safety in low-light conditions, thanks to its embedded reflective element.

The adaptable tether can be constructed from a strong and durable material that can be customized in length and strength to suit varying user needs. The tether is designed to have a locking mechanism that securely holds personal items such as water bottles, keys, mobile phones, wallets, tools, and many others. This locking functionality ensures that users can confidently keep their belongings within reach and have them securely fastened during their activities. The tether can be easily attached to backpacks, belts, clothing, or other gear by means of a carabiner, clip, hook or other innovative attachment mechanisms. In particular, these attachment points provide the user with a convenient method of holding and retrieving their personal belongings, without requiring constant readjustment or jeopardizing the safety of their items due to loss or theft.

The embodiment of this invention also includes a reflective element within the tether, thus offering enhanced visibility and safety to users during dusk, dawn, and nighttime scenarios. This reflective element could be in the form of a strip, coating, or stitching within the tether's fabric, which could capture and reflect light from headlights, lamps, streetlights, or other light sources. By incorporating this safety feature, users can be easily identifiable in instances of low visibility, reducing the risk of accidents and improving overall safety during walks, runs, hikes, or other outdoor activities. As a result, this inventive tether system significantly contributes to the market by addressing an unmet need for a practical, reliable, and safe solution that effectively safeguards personal belongings while enhancing users' visibility and overall safety.

In another embodiment, a tethered attachment feature effectively mitigates the occurrence of accidental dropping, misplacement, or damage to the eyewear. The system incorporates a fabric or textile loop, which is designed to have an anti-slip material or grip-enhancing texture as an integral part of its construction, ensuring the stability and security of the eyewear when it is attached to the user's shirt. The primary objective of this invention is to provide a practical, user-friendly, and efficient means for securing eyewear when it is not in use, reducing the likelihood of common issues associated with conventional eyewear storage methods, such as cases or neck straps. The material used for the loop is specifically chosen for its capacity to provide grip-enhancing properties or friction, ensuring that the eyewear does not slide or shift when it is tethered to the loop. The loop may be securely fastened to the user's clothing using a variety of attachment methods, such as a clip, adhesive backing, magnetic fastener, or any other suitable means of connection. In one embodiment, the anti-slip material or grip-enhancing texture might be incorporated into the inner surface of the loop, offering further stability and security for the eyewear.

Furthermore, the system provides a versatile and adaptable solution for various types of eyewear, such as glasses, sunglasses, or even goggles, and is suitable for users with diverse needs and preferences. The tethered eyewear attachment system is designed for quick and easy installation on various articles of clothing, offering unparalleled convenience and ease-of-use for the consumer. It can be readily adapted to accommodate different dimensions, sizes, and styles of eyewear, ensuring compatibility with a wide range of products on the market. Overall, the invention aims to offer a more practical and user-friendly alternative to more traditional eyewear storage and securing methods, addressing shortcomings and limitations of current solutions while enhancing user satisfaction and overall eyewear security.

In another implementation, the tether's unique structure incorporates a shock-absorbing component or mechanism, which serves to protect the eyewear during episodes of impact or stress that may occur during rigorous activities. This shock-absorbing component may be constructed from a resilient, flexible material or may take the form of a mechanical system designed to distribute impact forces evenly across the structure. The shock-absorbing component is strategically located between the point of attachment to the eyewear and the anchoring point on the user's body or clothing, ensuring that any forces exerted on the tether will be primarily absorbed by the shock-absorbing mechanism, helping to prevent damage to the eyewear or discomfort to the user.

In addition to providing enhanced stability and protection, the tether is also designed for ease of use and convenience. The device can be easily adjusted to fit various head and body sizes, and its attachment mechanism is designed to be compatible with a wide range of eyewear styles, including prescription glasses, sunglasses, and safety goggles. The tether may also incorporate additional features and benefits, such as a quick-release system, enabling rapid detachment and reattachment of the eyewear when necessary, or an adjustable tension system, allowing the user to customize the level of support and stability provided by the tether. By thoughtfully incorporating these features, the system offers a versatile and user-friendly solution to the practical challenges of securing and safeguarding eyewear during rigorous activities.

The reinforced attachment points of the shirt or clothing article can be strategically placed to suit the wearer's preferences or the requirements of a specific activity. This innovative design allows for customization, ensuring that the wearer can comfortably secure their eyewear device to their clothing without interfering with their range of motion or comfort during physical activities.

In addition to providing a secure means of attaching eyewear devices to clothing, the system also simplifies the process of donning and removing the device. With the eyewear tethered directly to the clothing, the wearer can easily slide the device on or off their face without the need to detach any straps or lanyards. This convenience is particularly beneficial for those who frequently need to remove their eyewear during an activity, such as a runner or cyclist who may need to wipe away sweat or adjust their eyewear periodically. The system provides an efficient, secure, and user-friendly method for attaching an eyewear device to a shirt or similar clothing article, preventing the device from becoming dislodged or separated from the wearer during physical activities. The method involves threading a tethering device through the temple piece opening of the eyewear device and the reinforced attachment points of the shirt, creating a secure and direct connection between the eyewear and the clothing. This innovative method enhances the wearer's comfort, convenience, and safety while engaging in various activities that require the use of eyewear devices.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the system have been described above, it should be understood that they have been presented by way of example only, and not of limitation. The various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the system. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the system should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the such as; the term “example” is used to provide exemplary instances of the item in discussion, not an exhaustive or limiting list thereof; the terms “a” or “an” should be read as meaning “at least one,” “one or more” or the such as; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Hence, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other such as phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the system. Various modifications to these embodiments will be readily apparent to those skilled in the art, and the generic principles defined herein may be applied to other embodiments without departing from the spirit or scope of the invention. Thus, the system is not intended to be limited to the embodiments shown herein but is to be accorded the widest scope consistent with the principles and novel features disclosed herein.

While there has been shown several and alternate embodiments of the system, it is to be understood that certain changes can be made as would be known to one skilled in the art without departing from the underlying scope of the invention as is discussed and set forth above and below. Furthermore, the embodiments described above are only intended to illustrate the principles of the system and are not intended to limit the scope of the invention to the disclosed elements.

What is claimed is:

1. A system for securing eyewear, the system comprising:
a temple piece having an opening or attachment point
a tether comprising a flexible cord or string; and
a shirt or article of clothing with a fabric or textile loop sewn thereon, or employing grommets or other secure eyelets,
wherein the tether is passed through the fabric or textile loop or grommet or eyelet, and its end is fastened to the opening or attachment point on the temple piece of the eyewear, thereby securely attaching the eyewear to the shirt, wherein the tether comprises two pieces, with these tethers being connected to one another after one or the other or both being passed through the loop, grommet, or eyelet.

2. The system of claim 1, wherein the fabric or textile loop is reinforced with additional stitching, or a grommet or eyelet made of a durable material is employed, to ensure durability and strength.

3. The system of claim 1, wherein the fabric or textile loop or a grommet or eyelet is made of a material that is resistant to breakage and tearing.

4. The system of claim 1, wherein the tether is adjustable or comprised of two connectable tethers, allowing the wearer to customize the length and tension of the tether according to their preference.

5. The system of claim 1, wherein the tether may be detachable or severable, providing the ability to easily remove and reattach the eyewear as desired by the wearer, including for use without the shirt that serves as the anchor point.

6. The system of claim 1, wherein the fabric or textile loop or grommet or eyelet is positioned on the back portion of the shirt or article of clothing to minimize interference with the wearer's comfort and range of motion.

7. The system of claim 1, wherein the fabric or textile loop or grommet or eyelet is positioned on the front portion of the shirt or article of clothing, allowing for easy access and visibility of the tethered eyewear.

8. The system of claim 1, wherein the fabric or textile loop includes a magnetic closure, providing a secure and convenient fastening mechanism for the tethered eyewear

9. The system of claim 1, wherein the fabric or textile loop is positioned on the collar or neckline of the shirt, providing a secure and convenient attachment point for the tethered eyewear.

10. The system of claim 1, wherein the fabric or textile loop is positioned on the shoulder or sleeve of the shirt, offering an alternative attachment location for the tethered eyewear.

11. The system of claim 1, further comprising an adjustable fastening mechanism on the temple piece, allowing for easy and secure attachment of the tether end to the opening or attachment point.

12. The system of claim 1, wherein the tether includes a quick-release mechanism, enabling rapid detachment of the tethered eyewear from the shirt in emergency situations.

13. The system of claim 1, wherein the tether includes a securing device, such as a clasp or hook, to ensure a reliable and sturdy connection between the tether and the opening or attachment point on the temple piece.

14. The system of claim 1, wherein the fabric or textile loop is detachable, allowing for easy replacement or interchangeability with different loops of varying designs and functionalities.

15. The system of claim 1, wherein the fabric or textile loop includes an identification tag or label, providing a means for personalization or branding of the tethered eyewear system.

16. The system of claim 1, wherein the fabric or textile loop includes additional pockets or compartments, offering storage space for small items such as keys or earphones.

17. The system of claim 1, wherein the tether includes a reflective element, enhancing visibility and safety in low-light conditions.

18. The system of claim 1, wherein the fabric or textile loop includes an anti-slip material or grip-enhancing texture, preventing the tethered eyewear from sliding or shifting on the shirt.

19. The system of claim 1, wherein the tether includes a shock-absorbing component or mechanism, protecting the eyewear from impact or damage during rigorous activities.

20. A method for securing an eyewear device, comprising the steps of:
a temple piece having an opening or attachment point
selecting a tethering device comprising a flexible cord or string;
threading the tethering device through the opening in the temple piece;
wearing a shirt or article of clothing with reinforced attachment points; and
passing the tethering device through the reinforced attachment points of the shirt;
securing the tethering device to the reinforced attachment points, thereby anchoring the eyewear device to the shirt;
whereby the method ensures a secure connection between the sunglasses and the shirt, preventing separation during physical activities.
